(19) United States
(12) Patent Application Publication
(10) Pub. No.: US 2016/0239586 A1
(43) Pub. Date: Aug. 18, 2016

(54) LIFETIME PREDICTION METHOD AND SYSTEM OF LITHIUM-ION BATTERY

(71) Applicant: HITACHI, LTD., Tokyo (JP)

(72) Inventor: Shirun HO, Tokyo (JP)

(21) Appl. No.: 14/380,509

(22) PCT Filed: Aug. 28, 2013
(86) PCT No.: PCT/JP2013/072942

§ 371 Date: Aug. 22, 2014

(51) Int. Cl. G06F 17/50; G06F 17/11; H01M 10/0525; H01M 10/42; H01M 10/48

(52) U.S. Cl. CPC G06F 17/5009; H01M 10/4257; H01M 10/4285; H01M 10/48; H01M 10/0525; H01M 10/4235; G06F 17/11; H01M 2010/4278

(57) ABSTRACT

In a method of predicting a lifetime of a lithium-ion battery, measurement data η^{exp} of a capacity retention η vs the number of charge and discharge cycles Nᵢ in the lithium-ion battery is first input. Then, a physical parameter p such as a reaction velocity factor for allowing solvent molecules reduced and decomposed by a negative electrode to react with a lithium ion dissolved in a electrolyte solution to generate a precursor of a solid electrolyte inter-phase in the physical model is set in a physical model. Calculation data η^{th} of the capacity retention η vs the number of charge and discharge cycles Nᵢ in the physical model is calculated with the use of two or more diffusion coefficients D^{SEI} and D^{pNE} to the solvent molecules. A mean square error O^{th} (D^{SEI}, D^{pNE}) of the measurement data η^{exp} and the calculation data η^{th} in the number of charge and discharge cycles Nᵢ are calculated. Then, values D^{SEI} and D^{pNE} of the diffusion coefficients where the mean square error O^{th} (D^{SEI}, D^{pNE}) is minimal are selected.

### TECHNICAL FIELD

The present invention relates a lifetime prediction method and system of a lithium-ion battery, and more particularly to a method and system for analyzing a physical factor for deteriorating a capacity retention at the time of charge and discharge and at the time of storage, and predicting the lifetime.

### BACKGROUND ART

With application expansion of portable devices, and an increase in mass production number, thin and lightweight lithium ion batteries become widespread. In the future, development the lithium-ion batteries to electric vehicles, a leveled power supply of a distributed stationary type, and industrial batteries have been expected, and further market growth is expected.

In the charge and discharge cycle dependence of the capacity retention, and the reserve time dependence of the capacity retention in the lithium-ion battery, an irreversible capacity has a tendency to increase in proportion to the number of charge and discharge cycles, and ½ power of a reserve time, experimentally, and is known as a root law. The root law of a phenomenological model is used to design a circuit and a system of the lithium ion battery.

For example, Nonpatent Literature 1 discloses a lifetime prediction technique of a large-capacity industrial lithium-ion battery that enables a high reliability design of the system using a root law of a phenomenon model.

On the other hand, there is a physical model approach which predicts the charge and discharge cycle dependence of the capacity retention, and the reserve time dependence of the capacity retention in the lithium-ion battery on the basis of a physical basic equation. Nonpatent Literature first proposes a solid electrolyte inter-phase model. Also, Nonpatent Literatures to 5 propose a physical model that focuses the diffusion phenomenon of organic solvent molecules.

Nonpatent Literature 6 reports the charge and discharge cycle number dependence of the capacity retention.

### CITATION LIST

### Nonpatent Literature

Nonpatent Literature 1: Abe, “Lifetime Prediction for Heavy-duty Industrial Lithium-ion Batteries that Enables highly Reliable System Design”, Hitachi Review, vol. 61, pp. 259-263, 2012
Nonpatent Literature 2: Peled, J. Electrochem. Soc., 126, pp. 2047-2051, 1979
Nonpatent Literature 3: Ploehn, J. Electrochem. Soc., 151, pp. A456-A462, 2004
Nonpatent Literature 4: T. Yoshida, J. Electrochem. Soc., 153, pp. A576-A582, 2006
Nonpatent Literature 5: B. Matthew, J. Electrochem. Soc., 160, pp. A243-A250, 2013
Nonpatent Literature 6:P. Liu, “Aging Mechanisms of LiFePO₄ Batteries Deduced by Electrochemical and Structure Analyses”, J. Electrochem. Soc., 157, pp. A499-A507, 2010

### SUMMARY OF INVENTION

### Technical Problem

In Nonpatent Literature 1, calculation data η^{ph} of charge and discharge cycle number Ni to a capacity retention η is used with the use of a fitting parameter A^{p} of the root law of the phenomenon model, and the calculation data η^{ph} of the charge and discharge cycle number Nᵢ to the capacity retention η is predicted with the use of the fitting parameter value A^{p} of the phenomenological model in which a mean square error O^{ph}(A^{p}) of calculation data η^{exp} and calculation data η^{ph} in the charge and discharge cycle number Ni becomes minimum. The same is applied to the reserve time dependence of the capacity retention.

Also, a sum rule to the charge and discharge cycle characteristic of the capacity retention and the reserve time characteristic of the capacity retention, and an activation energy of Arrhenius type to the fitting parameter are assumed. With the use of the fitting parameter thus extracted, the capacity retention after a long cycle, after a long reserve time, and at a specific temperature can be predicted. This is stable and high in reliability for compensating the capacity deterioration of the lithium-ion battery, and useful in the low-cost circuit and system design.

However, with the use of the root rule of the phenomenological model, it is difficult to physically interpret the value of the fitting parameter. Therefore, in the charge and discharge cycle characteristic and the reserve time characteristic of the capacity retention in the lithium-ion battery, analysis of the physical mechanism of the capacity deterioration and the proposal of the design guide of the long lifetime are difficult. Also, it is difficult to compare the parameter value fitted with the use of the phenomenological model with the value of the physical parameter obtained with the use of the molecular simulation. Further, it is difficult to compare the fitted parameter value with the value of the physical parameter obtained by high-level measurement.

On the other hand, in the physical model disclosed in Nonpatent Documents 2 to 5, the capacity deterioration is physically interpreted, but the physical interpretation is not unified, and the experimental results cannot be sufficiently reproduced. For the purpose of enhancing the consistency with the experimental results, further model development is essential to clarify the physical mechanism of the root rule to the capacity retention.

An object of the present invention is to provide a method and a system for predicting the lifetime of the lithium-ion battery on the basis of the physical model, which can sufficiently reproduce the experimental result.

### Solution to Problem

A typical example of the present invention will be described as follows. According to the present invention, there is provided a method of predicting a lifetime of a lithium-ion battery with the use of a physical model in which the lithium-ion battery includes a positive electrode, a negative electrode, and an electrolyte solution, the method including the steps of: setting the physical model; inputting measurement data η^{exp} of a capacity retention η vs the number of charge and discharge cycles Nᵢ in the lithium-ion battery; setting a physical parameter p such as a reaction velocity factor for allowing solvent molecules reduced and decomposed by the negative electrode to react with a lithium ion dissolved in the electrolyte solution to generate a precursor of a solid electrolyte inter-phase in the physical model; calculating calculation data η^{th} of the capacity retention η vs the number of charge and discharge cycles Nᵢ with the use of two or more diffusion coefficients D^{SEI} and D^{pNE} to the solvent molecules, using the physical parameter of the physical model; calculating a mean square error O^{th}(D^{SEI}, D^{pNE}) of the measurement data η^{exp} and the calculation data μ^{th} in the number of charge and discharge cycles Nᵢ; and selecting values D^{SEI} and D^{pNE} of the diffusion coefficients where the mean square error O^{th}(D^{SEI}, D^{pNE}) is minimum from the two or more kinds of diffusion coefficients D^{SEI} and D^{pNE}.

### Advantageous Effects of Invention

According to the present invention, the physical parameter obtained on the basis of the physical mode, for example, a physical parameter such as two or more kinds of diffusion coefficients to solvent molecules, and a reaction velocity factor for allowing solvent molecules reduced and decomposed by a negative electrode to react with a lithium ion dissolved in an electrolyte solution to generate a precursor of a solid electrolyte inter-phase in the physical model can be physically interpreted. Therefore, in the charge and discharge cycle characteristic, and the reserve time characteristic of the capacity retention in the lithium-ion battery, the physical mechanism of the capacity deterioration can be interpreted, and the design guide of the longer lifetime can be proposed.

### BRIEF DESCRIPTION OF DRAWINGS

FIG. 1 is a block diagram illustrating an example of procedure in a lifetime prediction method for a lithium-ion battery according to a first embodiment of the present invention.

FIG. 2 is a block diagram illustrating an example of a hardware configuration of a lifetime prediction system for the lithium-ion battery according to the first embodiment.

FIG. 3 is an illustrative view of an example of a physical model according to the present invention.

FIG. 4 is a diagram of measurement data of a capacity retention vs the number of charge and discharge cycles in the lithium-ion battery according to the first embodiment.

FIG. 5 is a diagram of calculation data and measurement data of the capacity retention vs the number of charge and discharge cycles in the lithium-ion battery according to the first embodiment.

FIG. 6 is a diagram of charge and discharge cycle number dependence of a diffusion coefficient of organic solvent molecules in a solid electrolyte inter-phase area according to the first embodiment.

FIG. 7 is a diagram of a charge and discharge cycle number dependence of a solid electrolyte inter-phase depth according to the first embodiment.

FIG. 8 is a block diagram illustrating an example of processing in a lifetime prediction method for a lithium-ion battery according to a second embodiment of the present invention.

FIG. 9 is a diagram of calculation data and measurement data of a capacity retention vs the number of charge and discharge cycles in a lithium-ion battery according to a third embodiment of the present invention.

FIG. 10 is a diagram illustrating a prediction system of a reserve time characteristic to a capacity retention of the lithium-ion battery according to a fourth embodiment of the present invention.

FIG. 11 is a diagram illustrating a prediction measurement of a reserve time characteristic to the capacity retention of the lithium-ion battery according to the fourth embodiment of the present invention.

### DESCRIPTION OF EMBODIMENTS

A typical outline of embodiments disclosed in the present application will be described below. That is, a method of predicting a lifetime of a lithium-ion battery with the use of a physical model according to a typical embodiment is a prediction method using the following procedure.
(1) Inputting measurement data η^{exp} of a capacity retention η vs the number of charge and discharge cycles Nᵢ in a lithium-ion battery.
(2) Setting a physical parameter p of a physical model such as a reaction velocity factor for allowing solvent molecules reduced and decomposed by a negative electrode to react with a lithium ion dissolved in an electrolyte solution to generate a precursor of a solid electrolyte inter-phase.
(3) Calculating calculation data η^{th} of the capacity retention η vs the number of charge and discharge cycles Nᵢ with the use of two or more diffusion coefficients D^{SEI} and D^{pNE} to the solvent molecules.
(4) Calculating a mean square error O^{th} (D^{SEI}, D^{pNE}) of the measurement data η^{exp} and the calculation data η^{th} related to the physical model in the number of charge and discharge cycles Nᵢ in the lithium-ion battery.
(5) Selecting values D^{SEI} and D^{pNE} of the diffusion coefficients where the mean square error O^{th}(D^{SEI}, D^{pNE}).

Hereinafter, embodiments of the present invention will be described in detail with reference to the drawings. In all of the drawings for illustrating the embodiments, identical parts are denoted by the same symbols in principle, and a repetitive description will be omitted.

### First Embodiment

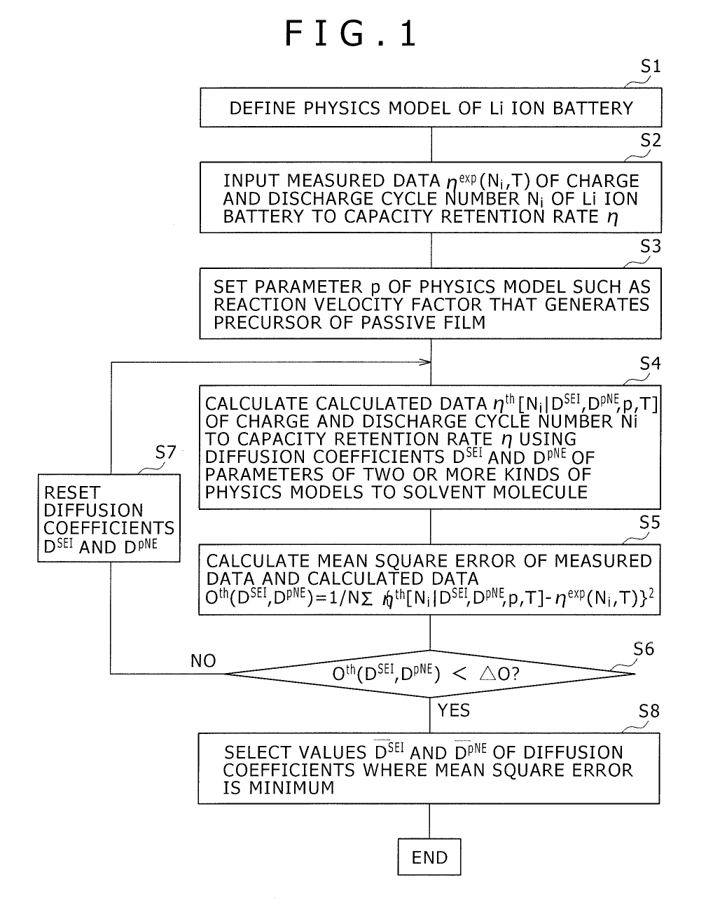

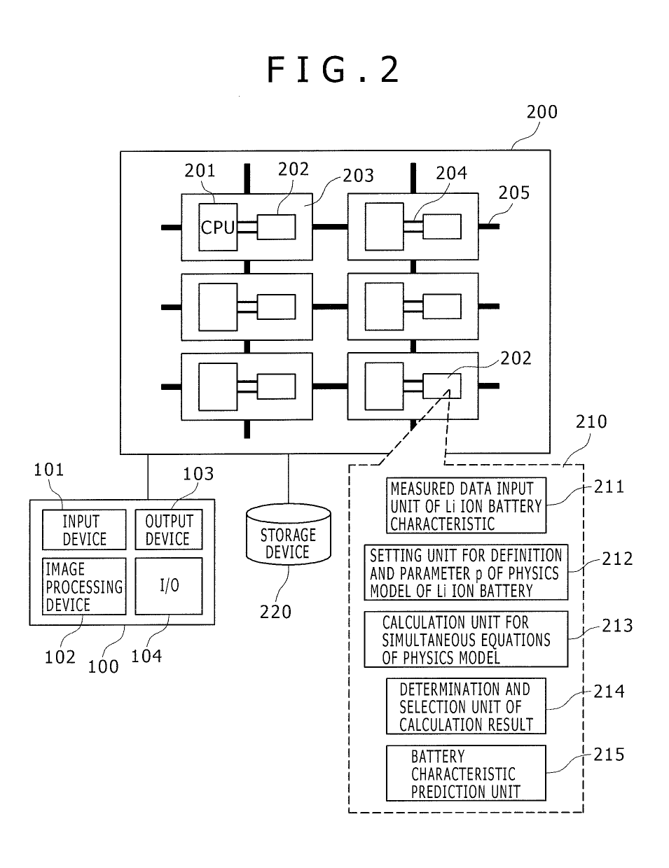

First, a lifetime prediction method and a system configuration for a lithium-ion battery according to a first embodiment of the present invention will be described with reference to FIGS. 1 and 2. FIG. 1 is a block diagram illustrating an example of procedure in a lifetime prediction method for a lithium-ion battery, and FIG. 2 is a block diagram illustrating an example of a hardware configuration of a lifetime prediction system for the lithium-ion battery.

A lifetime prediction system for a lithium-ion battery according to the first embodiment includes a computing system 200, and a personal computer 100 having a user interface function. A program for the lifetime prediction method of the lithium-ion battery is stored (retained) in a memory of the computing system 200, and a central processing unit of the computing system 200 reads the program, and conducts arithmetic processing according to an instruction from the personal computer. With the above configuration, the computing system functions as lifetime prediction means of the lithium-ion battery for conducting a series of processing.

In a procedure of the processing illustrated in FIG. 1, a physical model of the lithium-ion battery to be subjected to lifetime prediction through simulation is set. That is, a definition of the physical model is input (first step). Then, measurement data η^{exp} of a capacity retention η vs the number of charge and discharge cycles Nᵢ, which is measured with the use of the lithium-ion battery in a real equipment, is input (second step). Further, a parameter p of a physical model such as a reaction velocity factor for allowing solvent molecules reduced and decomposed by the negative electrode to react with a lithium ion dissolved in the electrolyte solution to generate a precursor of a solid electrolyte inter-phase is set (third step). Then, calculation data η^{th} of the capacity retention η vs the number of charge and discharge cycles Nᵢ is calculated with the use of two or more diffusion coefficients D^{SEI} and D^{pNE} to the solvent molecules which are defaults of the parameter p of the physical model (fourth step).

Then, a mean square error O^{th}(D^{SEI}, D^{pNE}) of the measurement data η^{exp} in the real equipment and the calculation data η^{th} in the physical model is calculated in the number of charge and discharge cycles Nᵢ (fifth step). Then, it is determined whether the mean square error O^{th} is equal to or lower than a given value Δ0, or not (sixth step). If the mean square error O^{th} is not equal to or lower than the given value Δ0, the diffusion coefficients D^{SEI} and D^{pNE} of the parameter are reset (seventh step), and the fourth and subsequent steps are repeated until the mean square error O^{th} becomes equal to or lower than the given value Δ0. In this way, values D^{SEI} and D^{pNE} of the diffusion coefficients where the mean square error O^{th}(D^{SEI}, D^{pNE}) is minimal can be selected (eighth step).

With the application of the values D^{SEI} and D^{pNE} of the diffusion coefficients of the physical model obtained as described above, the charge and discharge cycle characteristic to the capacity retention of the lithium-ion battery, which is high in the consistency with the measurement data in the real equipment can be obtained.

That is, the lifetime prediction system for the lithium-ion battery according to this embodiment is configured as the prediction system of the charge and discharge cycle characteristic to the capacity retention of the lithium-ion battery.

As illustrated in FIG. 2, respective computing devices 203 configuring the computing system 200 include a central processing unit 201, a memory 202, and a storage device 220, and those components are connected to each other by bus interferences for data transfer 204 and 205. The computing system 200 is configured so that the plural computing devices 203 are connected in a matrix by the bus interface for data transfer 205. The personal computer 100 includes an input device 101, a graphical processing device 102, an output device 103, and an input and output 104. The personal computer 100 functions as an input and output device of the computing system 200. In each of the computing devices 203, the program of the lifetime prediction method for the lithium-ion battery is stored (retained) is stored in the memory 202, and the central processing unit 201 reads the program, and conducts the arithmetic processing according to an instruction from the personal computer 100. The result of the arithmetic process is stored in the memory 202 or the storage device 220. The data necessary for the arithmetic processing is transmitted from the personal computer 100 through the bus interference for data transfer 205. Also, the result of the arithmetic processing in the computing device 203 is transmitted to the personal computer 100 through the bus interference for data transfer 205. Also, in the personal computer 100, data necessary for the arithmetic processing is input from the input device 101, and the result of the arithmetic processing is output and displayed on a monitor screen of the output device 103.

In FIG. 2, the plural computing devices 203 are configured to be connected to each other in a matrix by the bus interference for data transfer 205. However, the present invention is not limited to the above configuration, but the number of computing devices 203 configuring the computing system 200 may be one. Also, the program may be retained in the memory within the personal computer 100, and configured as the lifetime prediction system. Conversely, the computing system 200 per se may be provided with an input and output device.

The central processing unit 201 reads the program 210 in the memory 202, and conducts the arithmetic processing. As a result, the computing system 200 (and the personal computer 100) functions as a measurement data input unit 211 that inputs the measurement data η^{exp} of the lithium-ion battery characteristic, a setting unit 212 for the definition of the physical mode of the lithium-ion battery, and the parameter p, an arithmetic unit 213 related to the characteristic of the physical mode, a determination/selection unit 214 of the arithmetic result, and a battery characteristic prediction unit 215. The battery characteristic prediction unit 215 will be described with reference to the second embodiment.

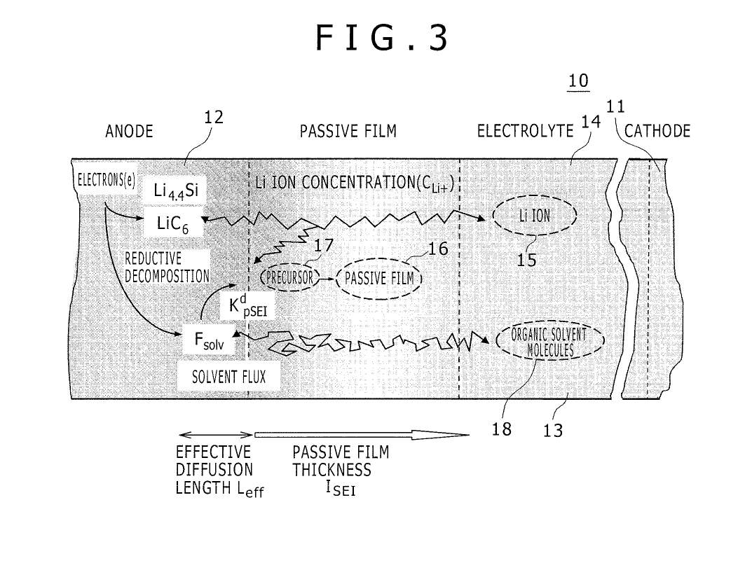

Subsequently, an example of the physical model that predicts the charge and discharge cycle characteristic of the capacity retention will be described with reference to FIG. 3. Like the real lithium-ion battery, a lithium-ion battery as the physical model includes a positive electrode 11, a negative electrode 12, a separator 13, an electrolyte solution 14 sealed within a space surrounded by those components, and an external circuit (not shown) that connects the positive electrode 11 and the negative electrode 12. The negative electrode 12 is made of graphite such as natural graphite, or artificial graphite, and the positive electrode 11 is made of Co, Ni, or Mn alloy. The electrolyte solution 14 is made of organic solvent such as EC (ethylene carbonate) or DEC (diethylene carbonate). When Li salt such as LiPH₆ is mixed with a mixture of the organic solvent, lithium ions 15 and PF₆ ions are dissociated from each other to produce the electrolyte solution an electrolyte solution in which the lithium ions and the PF₆ ions are dissolved. With the application of the voltage, the lithium ions 15 are conducted between the positive electrode 11 and the negative electrode 12 through the electrolyte solution 14.

In a charge process of the lithium-ion battery 10, a negative potential is applied to the positive electrode 11, and a positive potential is applied to the negative electrode 12. First, the Li atoms stored in in an active site of the positive electrode material are emitted into the electrolyte solution as lithium ions. In this situation, electrons are emitted into the positive electrode material, and the electrons flow in an external circuit. The emitted lithium ions are conducted in the electrolyte solution, and pass through the separator 13 having porous holes therein. Further, after the lithium ions that have been conducted in the electrolyte solution, the lithium ions enter the negative electrode material. The electrons are accepted from the negative electrode, and stored in an active site of the negative electrode material as the Li atoms. In this example, the active site of the negative electrode material is made of LiC₆ in graphite, and Li_{4.4}Si in Si alloy.

On the other hand, in a discharge process, the positive and negative electrodes are connected to a load resistor, or a positive potential is applied to the positive electrode 11, and a negative potential is applied to the negative electrode 12. The Li atoms stored in the active site of the negative electrode material are emitted into the electrolyte solution as the lithium ions 15. In this situation, electrons e are emitted to the negative electrode material, and the electrons flow into the external circuit. The emitted lithium ions are conducted in the electrolyte solution 14, and pass through the separator 13 having porous holes therein. Further, after the lithium ions have been conducted in the electrolyte solution, the lithium ions enter the positive electrode material. The electrons are accepted from the positive electrode 11, and stored in the active site of the positive electrode material as the Li atoms. The above charge and discharge operation is repeated to function as a storage battery. A reduced product obtained by reducing and decomposing organic solvent molecules 18 in an end surface of the negative electrode reacts with the lithium ions 15 to produce a precursor (pSEI) 17 of a solid electrolyte inter-phase (SEI) 16. Referring to FIG. 3, L_{eff} represents an effective diffusion length of the negative electrode 12, and L_{SEI} is a solid electrolyte inter-phase depth in the vicinity of the end surface of the negative electrode 12.

The theoretical capacity of the charge and discharge is 372 mAh/g in graphite (LiC₆) which is an active site of the negative electrode material, and 4200 mAh/g in Si alloy (Li_{4.4}Si). For the purpose of reducing the charging frequency of smartphones, or electric vehicles, the development of higher capacity negative electrode material is tried. Also, a potential at which the lithium ions enter the graphite negative electrode is higher than a normal electrode potential −3.05 V of Li+/Li by 0.05 V, and a potential at which the lithium ions enter the Si alloy negative electrode is higher than the normal electrode potential of Li+/Li by 0.4 V. Because the lithium-ion battery is larger in potential window of the charge and discharge, and high in energy density, the lithium-ion battery is hopeful as a next-generation storage battery.

However, because the volume expansion and contraction of the negative electrode material are generated to deteriorate the capacity at the time of charging and discharging the lithium ions, it is an issue to perform both of higher capacity and the longer lifetime. The solid electrolyte inter-phase 16 formed in an interface between the negative electrode material and the electrolyte solution has an important role in elongating the lifetime of the lithium-ion battery. At a potential higher than the normal electrode potential −3.05 V of Li+/Li by about 1 V, the organic solvent molecules 18 of the electrolyte solution is reduced and decomposed on the end surface of graphite or Si alloy. The reduced product reacts with the lithium ions to produce a film made of organic compound or inorganic compound. Although will be described in detail later, because the lithium ions are irreversibly consumed, an irreversible capacity is generated to deteriorate the capacity. On the other hand, the film of the organic compound has an ether chain (CH₂—CH₂—O)— of strong polar groups, and the lithium ions hop the polar groups, and can transmit through the polar groups with a low resistance. Also, because the films of the organic compound and the inorganic compound suppress the transmission of the organic solvent molecules, the reductive decomposition on the end surface of graphite or Si alloy is suppressed. That a selective transmission film that transmits the lithium ions and blocks the transmission of the organic solvent molecules is voluntarily formed in the vicinity of the end surface of negative electrode 12 as the solid electrolyte inter-phase 16 is key to supporting the longer lifetime of the lithium-ion battery.

Hereinafter, a description will be given of a method of predicting the charge and discharge cycle characteristic of the capacity retention by solving a simultaneous differential equation of the capacity retention and the solid electrolyte inter-phase depth L_{SEI} [cm] with the use of a flux density Fₛₒₗᵥ of the organic solvent molecules that disperse into two areas of the solid electrolyte inter-phase area and a porous negative electrode area with the application of the physical model of FIG.

As has been described with reference to FIG. 3, the reduced product obtained by reducing and decomposing the organic solvent molecules in the end surface of the negative electrode reacts with the lithium ions to produce the precursor (pSEI) 17 of the solid electrolyte inter-phase 16. Since the precursor pSEI of the solid electrolyte inter-phase is equal to the total mass of the solid electrolyte inter-phase made of ether chain CH₂—CH₂—O— of the organic compound or inorganic compound Li₂CO₃ formed after cascade reaction, a differential equation time to the solid electrolyte inter-phase depth l_{SEI} [cm] is represented by the following expression (1) with the capacity retention C_{Li+}/C⁰_{Li+}.

$$\begin{matrix}[ Ex . 1 ] & \\ \frac{d }{d t} \frac{{l}_{SEI}}{{L}_{eff}} = \frac{{M}_{pSEI} {C}_{{Li}^{+}}^{0}}{{M}_{SEI} {ρ}_{SEI}} {η}_{pSEI}^{d} {F}_{solv} ( t , {l}_{SEI} ) \frac{{C}_{{Li}^{+}}}{{C}_{{Li}^{+}}^{0}} & ( 1 )\end{matrix}$$

where C_{Li+} is a Li ion concentration, C⁰_{Li+} is a lithium ion concentration in an initial state, which is a reversible capacity stored in the positive electrode in the initial state. Hence, C_{Li+}/C⁰_{Li+} represents the capacity retention. Mᵢ(i=SEI, pSEI)[g/mol] is an average molar mass to I, and ρ_{SEI} [mol/L] is a molar density of the solid electrolyte inter-phase. Also, L_{eff}[cm] is an average length of a diffusion channel of the organic solvent molecules in the porous negative electrode material. η^{d}_{pSEI} [(mol/L)⁻¹ cm⁻¹] is a reaction coefficient for generating the precursor (pSEI) of the solid electrolyte inter-phase to a unit length of the diffusion channel of the organic solvent molecules. Fₛₒₗᵥ [mol/cm² s⁻¹] is an average flux density of the organic solvent molecules in the interface of the solid electrolyte inter-phase and the porous negative electrode area.

The capacity retention C_{Li+}/C⁰_{Li+} is reduced because the lithium ions react with the reduced product obtained by reducing and decomposing the organic solvent molecules to generate the precursor (pSEI) of a solid electrolyte inter-phase while the lithium ions are conducted between the positive electrode and the negative electrode through the electrolyte solution to repeat charge and discharge operation. Hence, a time differential equation to the capacity retention C_{Li+}/C⁰_{Li+} is represented as follows.

$$\begin{matrix}[ Ex . 2 ] & \\ \frac{d }{d t} \frac{{C}_{{Li}^{+}}}{{C}_{{Li}^{+}}^{0}} = - {η}_{pSEI}^{d} {F}_{solv} ( t , {l}_{SEI} ) \frac{{C}_{{Li}^{+}}}{{C}_{{Li}^{+}}^{0}} & ( 2 )\end{matrix}$$

Also, after the organic solvent molecules that have diffused into the electrolyte solution have diffused into the solid electrolyte inter-phase, the organic solvent molecules enter the porous negative electrode area, diffuse into gaps between grain boundaries, and reach the end surface of the negative electrode material. Therefore, the flux density Fₛₒₗᵥ[mol/cm² s⁻¹] of the organic solvent molecules in the interface between the solid electrolyte inter-phase and the porous negative electrode area is represented by the following Expression (3) by solving the diffusion equation of the organic solvent molecules.

$$\begin{matrix}[ Ex . 3 ] & \\ {F}_{solv} ( t , {l}_{SEI} ) = {C}_{solv}^{0} \sqrt{\frac{{D}^{avg}}{π t}} {\sum }_{n = 0}^{∞} {α}^{n} exp ( - \frac{{( 2 n + 1 )}^{2} {l}_{SEI}^{2}}{4 {D}_{t}^{SEI}} ) \\ {D}^{avg} = \frac{2 \sqrt{{D}^{SEI} {D}^{pNE}}}{\sqrt{{D}^{SEI}} + \sqrt{{D}^{pNE}}} , α = \frac{\sqrt{{D}^{pNE}} - \sqrt{{D}^{SEI}}}{\sqrt{{D}^{pNE}} + \sqrt{{D}^{SEI}}} & ( 3 )\end{matrix}$$

where D^{SEI} and D^{pNE} are diffusion coefficients of the organic solvent molecules in the solid electrolyte inter-phase and the porous negative electrode area. C⁰ₛₒₗᵥ is an organic solvent molecule concentration in the electrolyte solution. In this example, infinite series represent a process in which the organic solvent molecules diffuse into the solid electrolyte inter-phase between the negative electrode material interface and the electrolyte solution interface while multiple-reflecting.

Returning to FIG. 1, in the first step, the definition of the physical model of the lithium-ion battery is given as a simulation model as described in FIG. 3. In the second step, the measurement data η^{exp}(Nᵢ, T) of the capacity retention at the temperature T vs the number of charge and discharge cycles which is measured for the lithium-ion battery in the real equipment is input to the computing devices 203 from the input device 101 of the personal computer 100.

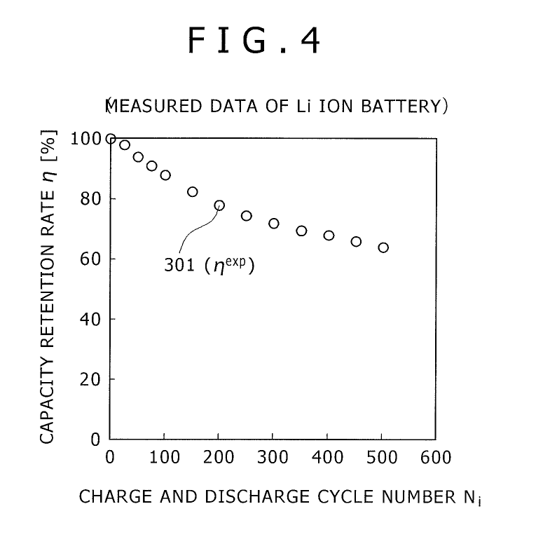

FIG. 4 illustrates an example of the measurement data of the capacity retention vs the number of charge and discharge cycles which is measured in the lithium-ion battery of the real equipment. In FIG. 4, respective plots indicated by reference numeral 301 represent measurement data μ^{exp} of the capacity retention vs the number of charge and discharge cycles Ni in the lithium-ion battery in the real equipment. The charge and discharge cycle number dependence of the capacity retention can be measured by a generally known method, as reported in, for example, Nonpatent Literature 6, and is not limited to the above measurement data.

Then, in the third step, the parameter (physical parameter) related to the physical model of the lithium-ion battery is input to the computing device 102 from the input device 101. Hereinafter, the physical parameters will be described. The physical parameters are the effective channel length L_{eff} at which the organic solvent molecules diffuse in the porous negative electrode area, the reaction velocity factor η^{d}_{pSEI} for generating the precursor of the solid electrolyte inter-phase, the average molar mass Mi (i=SEI, pSEI) of the solid electrolyte inter-phase or the precursor (pSEI) of the solid electrolyte inter-phase, the molar density ρ_{SEI} of the solid electrolyte inter-phase, the lithium ion concentration C⁰_{Li+} of the initial state, the organic solvent molecule concentration C⁰ₛₒₗᵥ in the electrolyte solution, and the time Tₚ of one step in the charge and discharge cycle. For example, L_{eff} 10⁻⁵ cm, μ^{d}_{pSEI}=10⁵ (mol/L)⁻¹ cm⁻¹, and Tₚ=400 s are set. From the viewpoint of reducing the number of parameters without essentially affecting the calculation results, ρ_{SEI}=C⁰_{Li+}=C⁰ₛₒₗᵥ [mol/L], and M_{pSEI}=M_{SEI} [g/mol] are set .

In the fourth step, two or more kinds of diffusion coefficients D^{SEI} and D^{pNE} to the organic solvent molecules in the solid electrolyte inter-phase and the porous negative electrode area in the physical model are set, and the calculation data rith of the capacity retention C_{Li+}/C⁰_{Li+} vs the number of charge and discharge cycles Ni is calculated. In this example, p is the physical parameter set in the third step. First, the solid electrolyte inter-phase depth l_{SEI}=0 and the capacity retention C_{Li}+/C⁰_{Li+}=1 at an initial time t₀ are set. In Expression (3), the diffusion coefficients D^{SEI} and D^{pNE} of the organic solvent molecules in the solid electrolyte inter-phase and the porous negative electrode area are set to arbitrary values to calculate the flux density Fₛₒₗᵥ of the organic solvent molecules in the interface between the solid electrolyte inter-phase and the porous negative electrode area. Then, right sides of Expressions (1) and (2) are obtained with the use of the Fₛₒₗᵥ, and the differential equation is solved to calculate the solid electrolyte inter-phase depth l_{SEI} and the capacity retention C_{Li}+/C⁰_{Li+} at a subsequent time t₀+Δt. This calculation is repeated to obtain the solid electrolyte inter-phase depth l_{SEI}, and the capacity retention C_{Li}+/C⁰_{Li+} at the time t. If the time t is divided by a time Tₚ of one step of the charge and discharge cycle, the solid electrolyte inter-phase depth l_{SEI} and the capacity retention C_{Li}+/C⁰_{Li+} to the number of charge and discharge cycles Ni can be obtained. In this situation, the capacity retention C_{Li}+/C⁰_{Li+} is the calculation data η^{th} [Nᵢ|D^{SEI}k, D^{pNE}, p, T] of the capacity retention vs the number of charge and discharge cycles Ni.

In the fifth step, the following Expression (4) representing the mean square error is calculated for the measurement data η^{exp} (Nᵢ, T) input in the second step, and the calculation data η^{th} [Nᵢ|D^{SEI}, D^{pNE}, p, T] calculated in the fourth step.

$$\begin{matrix}[ Ex . 4 ] & \\ {O}^{th} ( {D}^{SEI} , {D}^{pNE} ) = \frac{1}{N} {\sum }_{N = 1}^{N} {[ {η}^{th} ( {N}_{i} \vert {D}^{SEI} , {D}^{pNE} , p , T ) - {η}^{exp} ( {N}_{i} \vert T ) ]}^{2} & ( 4 )\end{matrix}$$

Subsequently, in the sixth step, it is determined whether the calculated mean square error O^{th} is equal to lower than a given value Δ0, or not. If the mean square error is sufficiently small, the diffusion coefficients D^{SEI} and D^{pNE} of the organic solvent molecules in which the mean square error Oth(DSEI, DpNE) is minimal are determined in the eighth step. If the mean square error is still larger, new diffusion coefficients D^{SEI} and D^{pNE} of the organic solvent molecules are set in the seventh step. Returning to the fourth step, the calculation data ith [Nᵢ|D^{SEI}, D^{pNE}, p, T] of the capacity retention vs the number of charge and discharge cycles Ni is again calculated.

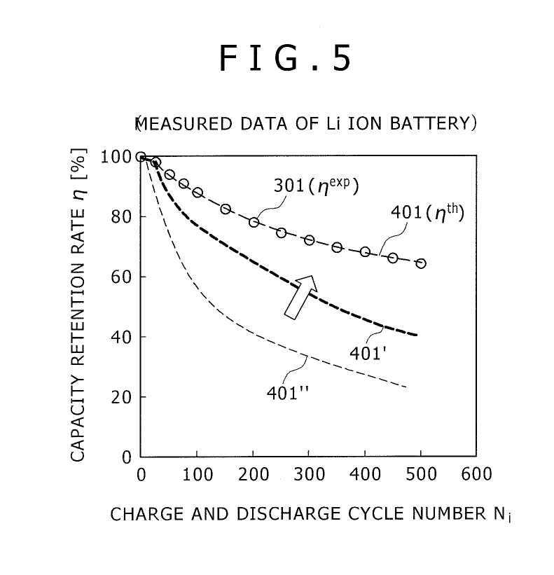

As an example, when the diffusion coefficients D^{SEI}=1.6×10⁻¹⁶ cm²/s and D^{pNE}=1.6×10⁻¹⁶ cm²/s of the organic solvent molecules in the solid electrolyte inter-phase and the porous negative electrode area are set, the mean square error of the measurement data and the calculation data of the number of charge and discharge cycles Ni to the capacity retention is 0.98. Also, when D^{SEI}=1.5×10⁻¹⁶ cm²/s and D^{pNE}=1.5×10⁻¹⁶ cm²/s are set, the mean square error is 0.64, that is, small. However, when D^{SEI}=1.4×10⁻¹⁶ cm²/s and D^{pNE}=1.4×10⁻¹⁶ cm²/s are set, the mean square error is 0.88, that is, large. Therefore, the diffusion coefficients D^{SEI}=1.5×10⁻¹⁶ cm²/sec and D^{pNE}=1.5×10⁻¹⁶ cm²/s of the organic solvent molecules in which the mean square error is minimal are selected. FIG. 5 illustrates the calculation data η^{th} [Nᵢ|D^{SEI},D^{pNE},p,T] of the capacity retention vs the number of charge and discharge cycles Ni when D^{SEI}=1.5×10⁻¹⁶ cm²/s, D^{pNE}=1.5×10⁻¹⁶ cm²/s are set as reference numeral 401. Also, symbols 401″ and 401′ are an example of the calculation data based on the various setting of the diffusion coefficients D^{SEI} and D^{pNE}. According to FIG. 5, the calculation data 401 high in consistence with the measurement data η^{exp} (experimental result) 301 can be obtained in the overall area of the charge and discharge cycles by appropriately setting the diffusion coefficients D^{SEI} and D^{pNE}.

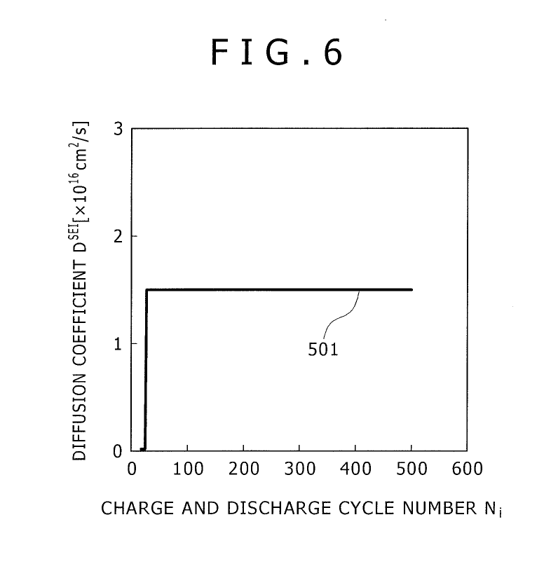

FIG. 6 illustrates calculation data 501 of dependency of the charge and discharge cycle number dependence Nᵢ of the diffusion coefficients D^{SEI} of the organic solvent molecules in the solid electrolyte inter-phase, which is resultantly obtained in the above processing. The same is applied to the charge and discharge cycle number dependence of the diffusion coefficients D^{pNE} of the organic solvent molecules in the porous negative electrode area. As illustrated in FIG. 6, since the diffusion coefficients D^{SEI} and D^{pNE} of the organic solvent molecules are low given values regardless of the number of charge and discharge cycles Ni, it is found that the solid electrolyte inter-phase formed by reducing and decomposing the organic solvent molecules holds an initial structure, and blocks the diffusion of the organic solvent molecules.

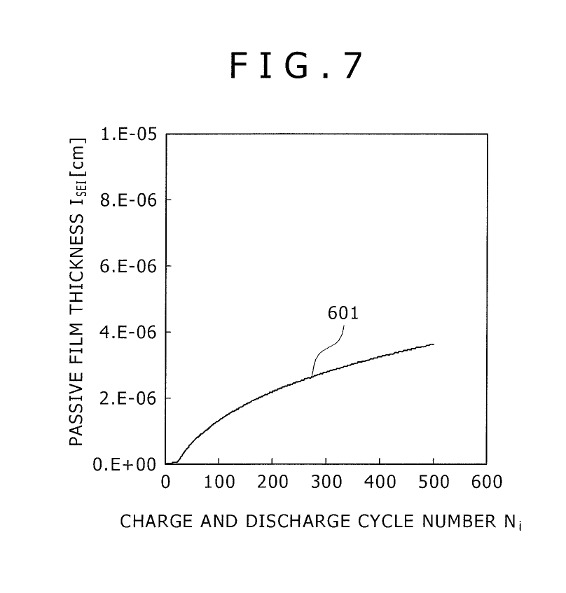

Also, FIG. 7 is illustrates calculation data 601 of dependency of the charge and discharge cycle number dependence Ni of the diffusion coefficients D^{SEI}, which is resultantly obtained in the above processing. It is found from FIG. 7 that the solid electrolyte inter-phase depth l^{SET} has a tendency to increase as the number of charge and discharge cycles Ni increases more. Because the thickness l^{SEI} of the solid electrolyte inter-phase can be measured with the use of measurement means such as an SEM after a wall of the lithium-ion battery in the real equipment which has been measured is opened, the validity of the lifetime prediction method for the lithium-ion battery based on the physical model 10 can be examined.

As has been described above, according to this embodiment, the physical parameters such as the two or more kinds of diffusion coefficients D^{SEI} and D^{pNE}, and the reaction rate coefficient η^{d}_{pSEI}(V) to the solvent molecules obtained on the basis of the physical model can be physically interpreted on the capacity deterioration of the lithium-ion battery. Therefore, in the charge and discharge cycle characteristic of the capacity retention in the lithium-ion battery, the physical mechanism of the capacity deterioration can be interpreted, and the design guide of the loner lifetime can be proposed.

The values of the diffusion coefficients D^{SEI} and D^{pNE} obtained with the physical model can be compared with the diffusion coefficients obtained with the use of the molecular simulation, or the values of the activation energy. For example, if the values of the diffusion coefficients obtained on the basis of the physical model is lower than the diffusion coefficients DSEI and DpNE obtained with the use of the molecular simulation under an ideal condition, it can be clarified that the diffusion coefficients are design guides for an improvement in the lifetime.

Further, the values of the diffusion coefficients obtained with the use of the physical model can be compared with the diffusion coefficients D^{SEI} and D^{pNE} obtained by high-level measurement, or the values of the activation energy. If the diffusion coefficients D^{SEI} and D^{pNE} obtained on the basis of the physical model are the same degree as that of the diffusion coefficients obtained with the use of the high-level measurement under a real condition, it can be clarified that the diffusion coefficients physically cause the capacity deterioration.

### Second Embodiment

In the next-generation lithium-ion battery, the higher capacity and the longer lifetime are problematic. For example, as the goal, the irreversible capacity when the number of charge and discharge cycles is 3000 is set to 10% or lower. In the second embodiment of the present invention, the diffusion coefficients in the solid electrolyte inter-phase and the porous negative electrode area for achieving this goal are designed.

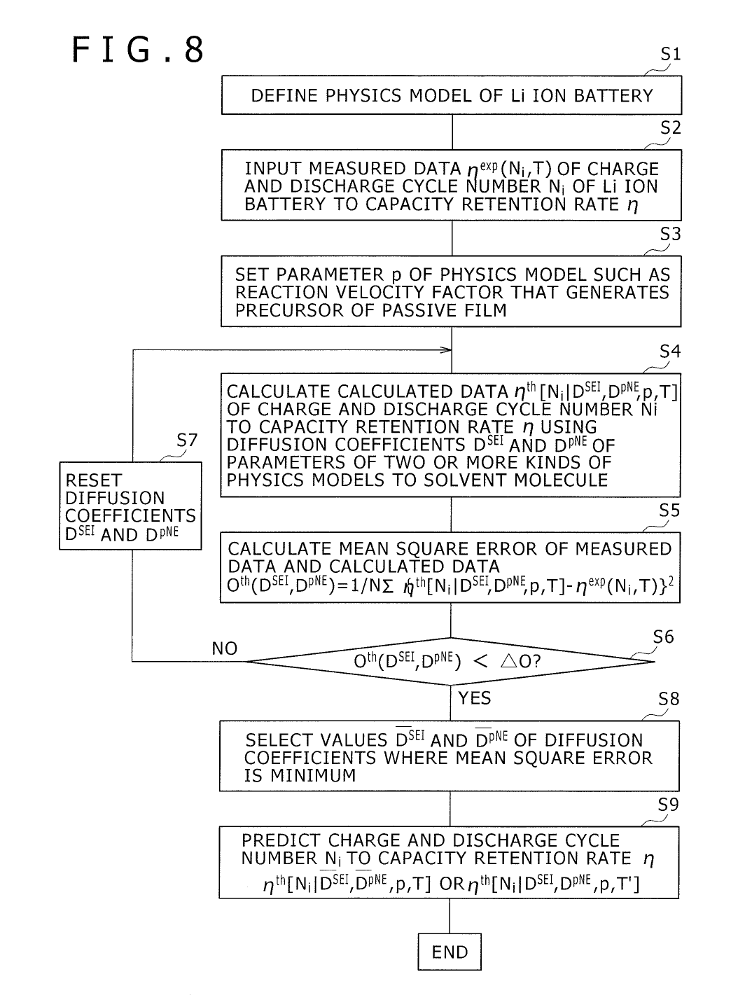

FIG. 8 is a block diagram illustrating an example of processing in the lifetime prediction method for a lithium-ion battery according to the second embodiment of the present invention.

Also, in the second embodiment, as illustrated in FIG. 8, as in the first embodiment, the first step to the eighth step are implemented to select diffusion coefficients D^{SEI}=1.5×10⁻¹⁶ cm²/s and D^{pNE}=1.5×10⁻¹⁶ cm²/s of the organic solvent molecules in which the mean square error is minimal.

In the ninth step, the calculation data η^{th} [Nᵢ|D^{SEI}, D^{pNE}, p, T] of the capacity retention vs the number of charge and discharge cycles Ni is predicted with the use of diffusion coefficients D^{SEI}, D^{pNE} of the organic solvent molecules in which the mean square error is minimal, which is obtained in the eighth step, as in the fourth step. The number of charge and discharge cycles is the number of long cycles larger than the number of charge and discharge cycles of the measurement data.

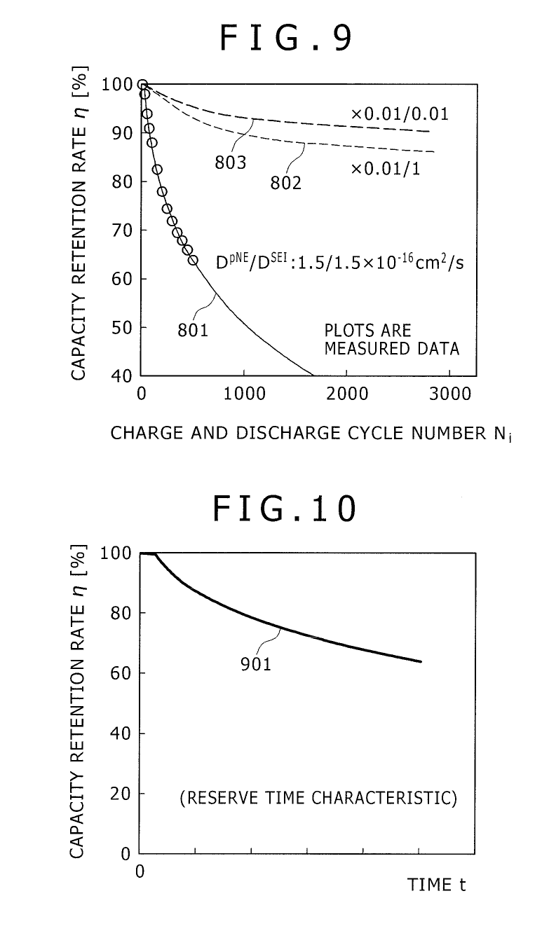

FIG. 9 is a diagram of calculation data of the capacity retention vs the number of charge and discharge cycles in the physical model of the lithium-ion battery, and the lithium-ion battery measurement data of the real equipment, in the lifetime prediction method for the lithium-ion battery according to this embodiment.

Referring to FIG. 9, a prediction characteristic 802 is calculation data η^{th} of the capacity retention vs the number of charge and discharge cycles when D^{SEI}=1.5×10⁻¹⁶ cm²/s and D^{pNE}=1.5×10⁻¹⁶ cm²/s are set. The capacity retention in the number of long cycles can be predicted so that the measurement data η^{exp} of the capacity retention shown in plots is extrapolated. As illustrated in FIG. 9, the capacity retention by the prediction characteristic 801 decreases by half in 1000 cycles, and the target lifetime cannot be satisfied.

On the other hand, in the prediction characteristic 802, the diffusion coefficient of the organic solvent molecules in the solid electrolyte inter-phase is set to D^{SEI}=1.5×10⁻¹⁶ cm²/s which is the same as that of the prediction characteristic 801, and the calculation data η^{th} [Nᵢ|D^{SEI},D^{pNE},p,T] of the capacity retention vs the number of charge and discharge cycles Ni when the diffusion coefficient of the organic solvent molecules in the porous negative electrode area is D^{pNE}=1.5×10⁻¹⁸ cm²/s which is 1/100 times of the prediction characteristic 801 is predicted. According to this prediction characteristic 802, the capacity retention is improved to 83.2% in 3000 cycles, that is, the irreversible capacity is remarkably reduced to 16.8% as compared with the prediction characteristic 801, but the target lifetime cannot be satisfied.

Under the circumstances, as indicated by the prediction characteristic 803, the calculation data η^{th} Nᵢ|D^{SEI},D^{pNE},p,T] of the capacity retention to the number of charge and discharge cycles Ni when both of the diffusion coefficients D^{SEI} and D^{pNE} of the organic solvent molecules in the solid electrolyte inter-phase and the porous negative electrode area are set to D^{SEI}=1.5×10⁻¹⁸ cm²/s and D^{pNE}=1.5×10⁻¹⁸ cm²/s which are 1/100 times (two-digit reduction) of the prediction characteristic 801 is predicted. According to this prediction characteristic 803, the capacity retention is improved to 88.7% in 3000 cycles, that is, the irreversible capacity is remarkably reduced to 11.3%, and the target lifetime can be substantially achieved.

In order to achieve the targets of the higher capacity and the longer lifetime in this way, the design guide can be obtained so that the diffusion coefficients of the organic solvent molecules in the solid electrolyte inter-phase and the porous negative electrode area can be reduced by two digits.

### Third Embodiment

The method of predicting the charge and discharge cycle characteristic of the capacity retention in the lithium-ion battery has been described above. The present invention is applied to the prediction system of the reserve time characteristic to the capacity retention in the lithium-ion battery according to the third embodiment. Since the reserve time (t) is a time Tₚ of the number of charge and discharge cycles Ni×one step of the charge and discharge cycles, as illustrated in FIG. 10, the method of predicting the reserve time characteristic 901 of the capacity retention η in the lithium-ion battery can be described as in the first and second embodiments.

Therefore, in not only the charge and discharge cycle characteristic of the capacity retention in the lithium-ion battery, but also the reserve time characteristic, the physical mechanism of the capacity deterioration can be interpreted, and the design guide of the loner lifetime can be proposed.

### Fourth Embodiment

Also, according to a fourth embodiment, the activation energies −E^{SEI} and E^{pNE} of the Arrhenius type at the temperature T can be obtained for the diffusion coefficients D^{SEI} and D^{pNE} of the organic solvent molecules in the solid electrolyte inter-phase obtained on the basis of the physical model, and the porous negative electrode area. If those values are changed to the values D^{SEI} and D^{pNE} of the diffusion coefficients of the organic solvent molecules at the different temperature T′ with the use of the activation energies E^{SEI} and E^{pNE}, the charge and discharge cycle characteristic of the capacity retention and the reserve time characteristic at the different temperature T can be predicted.

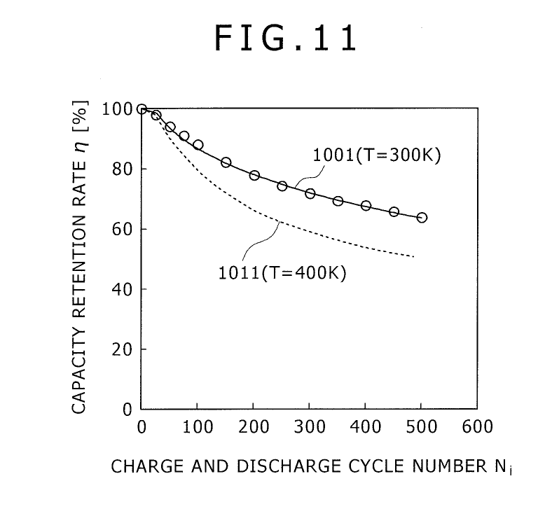

For example, as illustrated in FIG. 11, the charge and discharge cycle characteristic 1001 of the capacity retention at the different temperature T=400 k can be predicted on the basis of the charge and discharge cycle characteristic 1011 of the capacity retention at the temperature T=300 k obtained in the method of the first embodiment.

### Fifth Embodiment

Also, in the physical model 10 of FIG. 3, a case in which the reduced product obtained by reducing and decomposing the organic solvent molecules on the end surface of the negative electrode 12 reacts with the lithium ions 15 to generate the precursor pSEI of the solid electrolyte inter-phase has been described. As the physical model of the lithium-ion battery different from the above case, also in the case where the reduced product obtained by reducing and decomposing the organic solvent molecules on the end surface of the positive electrode 11 reacts with the lithium ions 15 to generate the precursor pSEI of the solid electrolyte inter-phase has been described, the charge and discharge cycle characteristic and the reserve time characteristic of the capacity retention in the lithium-ion battery can be predicated.

Further, the invention made by the present inventors has been described on the basis of the embodiments. However, the present invention is not limited to the embodiment, but can be variously changed without departing from a spirit thereof.

### LISTS OF REFERENCE SIGNS

10, physical model of a lithium-ion battery; 11, positive electrode; 12, negative electrode; 13, separator; 14, electrolyte solution; 15, Li ion; 16, solid electrolyte inter-phase (SEI); 17, precursor of the solid electrolyte inter-phase (pSEI); 18, organic solvent molecule; 100, personal computer; 101, input device; 102, graphical processing device; 103, output device; 104, input and output; 200, computing system; 201, central processing unit; 202, memory; 203, computing device; 204, bus interface for data transfer; 205, bus interface for data transfer; 301, measurement data of capacity retention vs the number of charge and discharge cycles in the lithium-ion battery; 401, calculation data of the capacity retention vs the number of charge and discharge cycles in the lithium-ion battery; 501, calculation data of charge and discharge cycle number dependence of diffusion coefficient of organic solvent molecules in a solid electrolyte inter-phase area; 601, calculation data of charge and discharge cycle number dependence of solid electrolyte inter-phase depth; 801 to 803, calculation data of capacity retention to the number of charge and discharge cycles in the lithium-ion battery; and 901 to Li, reserve time characteristic of the capacity retention η in the lithium-ion battery.

1. A method of predicting a lifetime of a lithium-ion battery with the use of a physical model corresponding to the lithium-ion battery in which the lithium-ion battery includes a positive electrode, a negative electrode, and an electrolyte solution, the method comprising the steps of:
setting the physical model;
inputting measurement data η^{exp} of a capacity retention η vs the number of charge and discharge cycles Nᵢ in the lithium-ion battery;
setting a physical parameter p such as a reaction velocity factor for allowing solvent molecules reduced and decomposed by the negative electrode to react with a lithium ion dissolved in the electrolyte solution to generate a precursor of a solid electrolyte inter-phase in the physical model;
calculating calculation data η^{th} of the capacity retention η vs the number of charge and discharge cycles Nᵢ with the use of two or more diffusion coefficients D^{SEI} and D^{pNE} to the solvent molecules, using the physical parameter of the physical model;
calculating a mean square error O^{th} (D^{SEI}, D^{pNE}) of the measurement data η^{exp} and the calculation data η^{th} in the number of charge and discharge cycles Nᵢ; and
selecting values D^{SEI} and D^{pNE} of the diffusion coefficients where the mean square error Oth(DSEI, DpNE) is minimal from the two or more kinds of diffusion coefficients D^{SEI} and D^{pNE}.

2. The method of predicting a lifetime of a lithium-ion battery according to claim 1, further comprising the step of:
predicting the calculation data of the capacity retention η vs the number of long cycles Nᵢ with fixing to the selected values D^{SEI} and D^{pNE} of the diffusion coefficients.

3. The method of predicting a lifetime of a lithium-ion battery according to claim 1, further comprising the step of:
predicting the calculation data η^{th} of the capacity retention η vs the number of long cycles Nᵢ with the use of the values D^{SEI} and D^{pNE} of the diffusion coefficients which are multiplied by an arbitrary multiple on the basis of the selected values D^{SEI} and D^{pNE} of the diffusion coefficients.

4. The method of predicting a lifetime of a lithium-ion battery according to claim 1, further comprising the step of:
predicting the calculation data η^{th} of the capacity retention η vs the number of long cycles Nᵢ by obtaining activation energies E^{SEI} and E^{pNE} of Arrhenius type at a temperature T on the basis of the selected values D^{SEI} and D^{pNE} of the diffusion coefficients, and changing to values D^{SEI} and D^{pNE} of the diffusion coefficients at a different temperature T′ with the use of the activation energies E^{SEI} and E^{pNE}.

5. The method of predicting a lifetime of a lithium-ion battery according to claim 1, further comprising the step of:
predicting the calculation data η^{th} of the capacity retention η vs the number of long cycles Nᵢ by changing the physical parameter p with fixing to the selected values D^{SEI} and D^{pNE} of the diffusion coefficients.

6. The method of predicting a lifetime of a lithium-ion battery according to claim 1, further comprising the step of:
predicting a reserve time characteristic of the capacity retention in the lithium-ion battery with a value obtained by multiplying the number of charge and discharge cycles Ni by a time Tₚ in one step of the charge and discharge cycle as a reserve time (t).

7. The method of predicting a lifetime of a lithium-ion battery according to claim 1,
wherein in the physical model, a reduced product obtained by reducing and decomposing organic solvent molecules in an end surface area of the negative electrode reacts with lithium ions to produce a precursor pSEI of a solid electrolyte inter-phase, and
wherein a charge and discharge cycle characteristic of the capacity retention is predicted by solving a simultaneous differential equation of the capacity retention and the solid electrolyte inter-phase depth with the use of a flux density of the organic solvent molecules that disperse into two areas of the solid electrolyte inter-phase area and a porous negative electrode area.

8. The method of predicting a lifetime of a lithium-ion battery according to claim 1,
wherein in the physical model, an oxide obtained by oxidizing and decomposing organic solvent molecules in an end surface of the positive electrode reacts with lithium ions to produce a precursor pSEI of a solid electrolyte inter-phase, and
wherein a charge and discharge cycle characteristic of the capacity retention is predicted by solving a simultaneous differential equation of the capacity retention and the solid electrolyte inter-phase depth with the use of a flux density of the organic solvent molecules that disperse into two areas of the solid electrolyte inter-phase area and a porous positive electrode area.

9. A method of predicting a lifetime of a lithium-ion battery with the use of a physical model corresponding to the lithium-ion battery in which the lithium-ion battery includes a positive electrode, a negative electrode, and an electrolyte solution, the method comprising the steps of:
wherein in the physical model, a reduced product obtained by reducing and decomposing organic solvent molecules in an end surface area of the negative electrode reacts with lithium ions to produce a precursor pSEI of a solid electrolyte inter-phase, and
wherein a charge and discharge cycle characteristic of the capacity retention is predicted by solving a simultaneous differential equation of the capacity retention and the solid electrolyte inter-phase depth with the use of a flux density of the organic solvent molecules that disperse into two areas of the solid electrolyte inter-phase area and a porous negative electrode area.

10. The method of predicting a lifetime of a lithium-ion battery according to claim 9,
wherein a flux density Fₛₒₗᵥ [mol/cm²] of the organic solvent molecules in an interface between the solid electrolyte inter-phase area and a porous negative electrode area is given by the following Expression (3) as the simultaneous differential equation.
$$\begin{matrix}[ Ex . 5 ] & \\ \frac{d }{d t} \frac{{l}_{SEI}}{{L}_{eff}} = \frac{{M}_{pSEI} {C}_{{Li}^{+}}^{0}}{{M}_{SEI} {ρ}_{SEI}} {η}_{pSEI}^{d} {F}_{solv} ( t , {l}_{SEI} ) \frac{{C}_{{Li}^{+}}}{{C}_{{Li}^{+}}^{0}} & ( 1 )\end{matrix}$$
where D^{SEI} and D^{pNE} are diffusion coefficients of the organic solvent molecules in a solid electrolyte inter-phase area and a porous negative electrode area, and C⁰ₛₒₗᵥ is an organic solvent molecule concentration in an electrolyte solution.

11. The method of predicting a lifetime of a lithium-ion battery according to claim 10, further comprising the steps of:
setting the physical model;
inputting measurement data η^{exp} of a capacity retention η vs the number of charge and discharge cycles Nᵢ in an actual equipment of the lithium-ion battery;
setting a physical parameter p such as a reaction velocity factor for allowing solvent molecules reduced and decomposed by the negative electrode to react with a lithium ion dissolved in the electrolyte solution to generate the precursor of the solid electrolyte inter-phase in the physical model;
calculating calculation data η^{th} of the capacity retention η vs the number of charge and discharge cycles Nᵢ with the use of two or more diffusion coefficients D^{SEI} and D^{pNE} to the solvent molecules, using the physical parameter of the physical model;
calculating a mean square error O^{th}(D^{SEI}, D^{pNE}) of the measurement data and the calculation data η^{th} in the number of charge and discharge cycles Nᵢ; and
selecting values D^{SEI} and D^{pNE} of the diffusion coefficients where the mean square error O^{th} (D^{SEI}, D^{pNE}) is minimal from the two or more kinds of diffusion coefficients D^{SEI} and D^{pNE}.

12. The method of predicting a lifetime of a lithium-ion battery according to claim 11, further comprising the step of:
predicting the calculation data η^{th} of the capacity retention η vs the number of long cycles Nᵢ with fixing to the selected values D^{SEI} and D^{pNE} of the diffusion coefficients.

13. A lifetime prediction system of a lithium-ion battery, comprising:
a CPU that executes arithmetic processing;
a computing device having a program executed by the CPU, and a storage device that stores data;
an input device for inputting the data to the computing device;
a setting unit, an arithmetic unit, and a determination/selection unit of an arithmetic result; and
an output device for outputting the arithmetic result in the computing device, in which the lithium-ion battery includes a positive electrode, a negative electrode, and an electrolyte solution, wherein
the input device inputs measurement data rff of a capacity retention η vs the number of charge and discharge cycles Nᵢ in the lithium-ion battery of a real equipment,
the setting unit sets a physical parameter p such as a reaction velocity factor for allowing solvent molecules reduced and decomposed by the negative electrode to react with a lithium ion dissolved in the electrolyte solution to generate a precursor of a solid electrolyte inter-phase in the physical model,
the arithmetic unit calculates calculation data η^{th} of the capacity retention η vs the number of charge and discharge cycles Nᵢ with the use of two or more diffusion coefficients D^{SEI} and D^{pNE} to the solvent molecules, and also calculates a mean square error O^{th}(D^{SEI}, D^{pNE}) of the measurement data η^{exp} and the calculation data η^{th} in the number of charge and discharge cycles Nᵢ,
the determination/selection unit of the arithmetic result selects values D^{SEI} and D^{pNE} of the diffusion coefficients where the mean square error O^{th}(D^{SEI}, D^{PNE}) is minimum, and
the output device outputs the selection result.

14. The lifetime prediction system of a lithium-ion battery according to claim 13, further comprising:
a battery characteristic prediction unit,
wherein the battery characteristic prediction unit predicts the calculation data η^{th} of the capacity retention η vs the number of long cycles Nᵢ with fixing to the selected values D^{SEI} and D^{pNE} of the diffusion coefficients.

15. The lifetime prediction system of a lithium-ion battery according to claim 13, further comprising:
a battery characteristic prediction unit,
wherein the battery characteristic prediction unit predicts the calculation data η^{th} of the capacity retention η vs the number of long cycles Nᵢ with the use of the values D^{SEI} and D^{pNE} of the diffusion coefficients which are multiplied by an arbitrary multiple on the basis of the selected values D^{SEI} and D^{pNE} of the diffusion coefficients.
